(19) United States
(12) Patent Application Publication
(10) Pub. No.: US 2004/0083847 A1
(43) Pub. Date: May 6, 2004

(54) Assembly element for a foot parking brake

(76) Inventors: Eckhard Reese, Apensen (DE); Thomas Roepke, Stelle (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/466,181

(22) PCT Filed: Dec. 20, 2001
(86) PCT No.: PCT/EP01/15158

(30) Foreign Application Priority Data
Jan. 12, 2001 (DE) 101 01 220.9

(51) Int. Cl. G05G 1/14

(52) U.S. Cl. 74/512

(57) ABSTRACT

In order to provide a mounting element for a foot-operated parking brake in a motor vehicle, the said mounting element being fastened in the driver-side foot space in the region of connection of an end wall to an end-wall column by means of screw connections and having components of the foot-operated parking brake connected to it, in order to arrange these for use in the vehicle, the said mounting element being light and at the same time being cost-effective to produce, it is proposed to have a mounting element made of plastic, in which the connection points between the mounting element and components of the foot-operated parking brake which are fastened to it are designed as metal inlay parts injection-molded around with the plastic of the mounting element, and in which these metal inlay parts are arranged in the region of the screw connections which serve for fastening the mounting element to the body.

The invention relates to a mounting element for a foot-operated parking brake in a motor vehicle, the said mounting element being fastened in the driver-side foot space in the region of connection of an end wall to an end-wall column (A-column). Components of the foot-operated parking brake are connected to this mounting element in order to arrange these for use in the vehicle.

Mounting elements of this type are known in the prior art. Reference is made in this respect, for example, to DE 34 13 030 A1. Known mounting elements consist, as a rule, of sheet steel. They are then cost-effective to produce. However, their high weight entails a considerable disadvantage. If the known mounting elements are produced from light cast metal, the weight is admittedly reduced. However, the costs rise when this material is used.

Against this background, the object on which the present invention is based is to provide a mounting element for a foot-operated parking brake in a motor vehicle, the said mounting element being light and at the same time being cost-effective to produce.

In a mounting element for a foot-operated parking brake, having the features of the precharacterizing clause of claim 1, this object is achieved by means of the features of the characterizing clause of claim 1.

Accordingly, the invention is distinguished in that the mounting element for a foot-operated parking brake in a motor vehicle, the mounting element being fastened in the driver-side foot space in the region of connection of an end wall to an end-wall column (A-column) by means of screw connections and having components of a foot-operated parking brake connected to it in order to arrange these for use in the vehicle, consists of plastic. Connection points between the mounting element and the components of the foot-operated parking brake which are fastened to it consist, according to the invention, of metal inlay parts injection-molded around with the plastic of the mounting element. These metal inlay parts are arranged in the region of the screw connections which serve for fastening the mounting element to the body.

The mounting element according to the invention affords the advantage that, because it consists of plastic, it is both light and cost-effective to produce. Points on the mounting element which are subjected to high stress are reinforced by means of inlay parts made of metal, so that the mounting element withstands the loads. Moreover, the metal-reinforced points subjected to high stress are arranged in the region of the screw connections which serve for fastening the mounting element to the body. As a result, a large part of the forces occurring during the actuation of the foot-operated parking brake is introduced directly into the body. What is achieved thereby is that, even under continuous load, under which plastic usually begins to flow, the mounting element according to the invention remains dimensionally stable, since the force is transferred directly from the introduction point into the body. In this case, the metal inlay parts transmit the forces, whilst the plastic mounting element assumes virtually only a supporting and bearing function for the components of the brake.

The production of the mounting element according to the invention is very simple. The metal inlay parts are inlaid into a mold into which plastic is subsequently injected. In this case, the metal inlay parts are injection-molded around and are tied firmly into the mounting element. This simple production method is conducive to the low costs for the mounting element.

Advantageous embodiments may be gathered from the subclaims.

Accordingly, the connection point between the mounting element and a shaft of a pivotably mounted pedal of the foot-operated parking brake may be designed as a metal inlay part injection-molded around with the plastic of the mounting element. The shaft consists of metal and is configured in such a way that it is connected directly to the body via a screw connection which serves for fastening the mounting element to the body. A large part of the force introduced by the pedal is consequently transferred directly to the body, without being conducted via the plastic of the mounting element.

A sheet-like ring arranged at that end of the shaft which is assigned to the mounting element is surrounded by the plastic of the mounting element and supports the shaft on the latter. Indentations may be introduced at regular intervals into this ring, for example into its circumference. The purpose of these indentations is, during the injection of plastic, to be filled with the latter, thus resulting in a rotationally fixed connection between the ring and the mounting element.

In the region of a cable support, the mounting element is reinforced by a further metal inlay part. The mounting element is fastened to the body through the metal inlay part by means of a screw. Consequently, owing to the metal reinforcement, this region is dimensionally stable and transmits forces introduced by the cable directly into the body, thus leading to the plastic mounting part being relieved.

The invention is explained in more detail below with reference to the exemplary embodiment illustrated in the drawing in which:

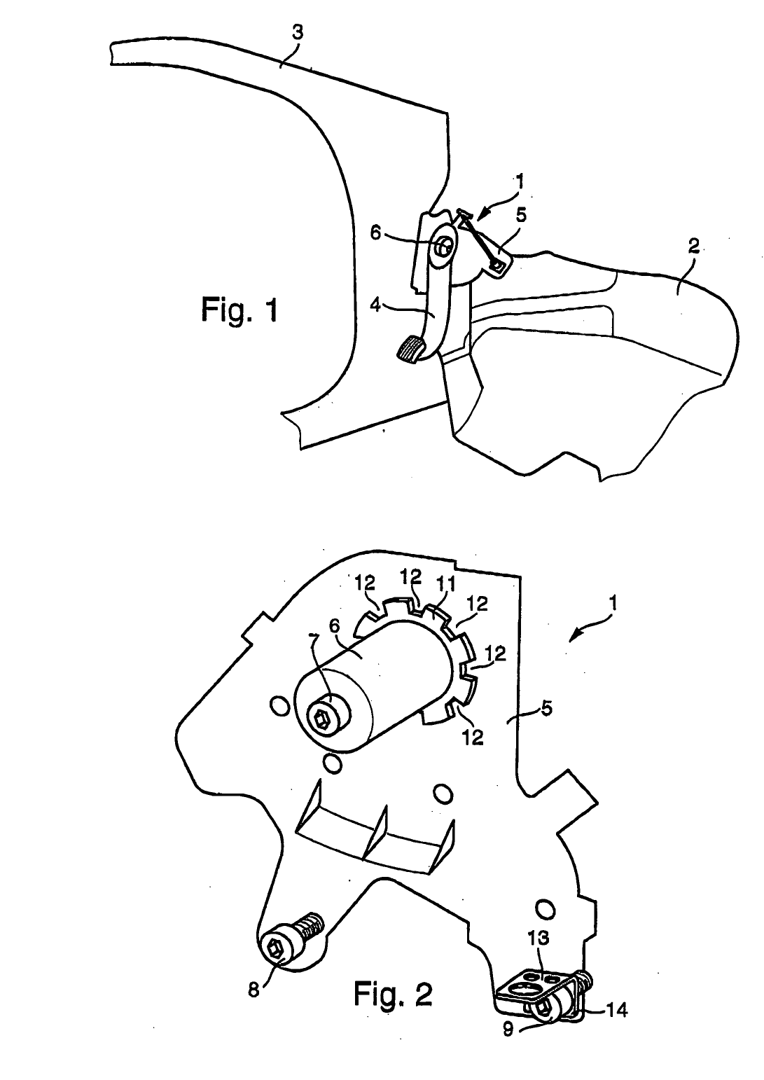

FIG. 1 shows a driver-side foot space with a foot-operated parking brake which is arranged on a mounting element according to the invention, and

FIG. 2 shows a mounting element according to the invention with metal-reinforced connection points.

As illustrated in FIG. 1, a foot-operated parking brake 1 is arranged in the driver-side foot space in the region of connection between an end wall 2 and an end-wall column (A-column) 3. The foot-operated parking brake 1 has a pedal 4. The pedal 4 is arranged, mounted rotatably about a shaft 6, on a plate-shaped mounting element 5. The mounting element 5 consists predominantly of plastic.

As may be gathered from FIG. 2, the mounting element 5 is fastened at three points 7, 8, 9 to the body, specifically to the region of connection between the end wall 2 and the A-column 3. The fastening means used are screws.

By means of the screw 7, not only the mounting element 5, but also the shaft 6, about which the pedal 4 is pivotable, is fastened to the body. The shaft 6 consists of metal. It has a ring 11 at its end facing the mounting element 5. Indentations 12 are introduced into the circumference of the ring 11. The ring 11 is embedded into the plastic of the mounting element 5, so that the shaft 6 and the mounting element 5 form one part. The indentations 12 are conducive to a rotationally fixed connection between the mounting element 5 and the shaft 6.

Since the shaft 6 is fastened directly to the body via the screw 7, a large part of the forces occurring during the actuation of the pedal 4 is introduced directly into the body. The mounting element 5 here assumes only a supporting or bearing function and is therefore not subjected to excessive stress.

For a cable support of the foot-operated parking brake, a further metal inlay part 13 is introduced into the mounting element 5. This metal inlay part has a sheet-like portion 14 arranged at that end of the cable support 13 which points towards the mounting element 5. The sheet-like portion 14 is injection-molded around with plastic and makes the connection between the mounting element 5 and the metal inlay part of the cable support 13. The screw 9 is led through this sheet-like portion 14 of the metal inlay part 13. The forces introduced into the metal inlay part 13 by the cable are thereby likewise introduced directly to the body and the mounting element 5 is thus relieved.

The screw 8 is introduced directly into the plastic mounting element 5, in order to fasten the latter to the body. The mounting element 5 is not reinforced here. It is sufficient, here, to have a bush, not illustrated, around the fastening hole, likewise not illustrated, in the mounting element 5.

1. Mounting element for a foot-operated parking brake in a motor vehicle, said mounting element being fastened in the driver-side foot space in the region of connection of an end wall of the body to an end-wall column by means of screw connections and having components of the foot-operated parking brake connected to it in order to arrange these for use in the vehicle, characterized in that the mounting element (5) is made of plastic and the connection points between the mounting element (5) and the components of the foot-operated parking brake (1) which are fastened to it are designed as metal inlay parts (11, 13) injection-molded around with the plastic of the mounting element (5), and in that these metal inlay parts (11, 13) are arranged in the region of the screw connections (7, 9) which serve for fastening the mounting element (5) to the body.

2. Mounting element according to claim 1, characterized in that the connection point between the mounting element (5) and a shaft (6) of a pivotably mounted pedal (4) of the foot-operated parking brake (1) is designed as a metal inlay part (11) injection-molded around with the plastic of the mounting element.

3. Mounting element according to claim 1 or 2, characterized in that the screw (7) connects the shaft (6) and the mounting element (5) directly to the body.

4. Mounting element according to one of claims 1 to 3, characterized in that the shaft (6) of the pedal (4) has a sheet like ring (11) as a metal inlay part which extends perpendicularly to the shaft (6) and which is arranged at that end of the shaft (6) which is connected to the mounting element (5).

5. Mounting element according to one of claims 1 to 4, characterized in that the ring (11) has indentations (12) which are arranged at regular intervals on the circumference of the ring (11).

6. Mounting element according to claim 1, characterized in that the connection point between the mounting element (5) and a cable support of the foot-operated parking brake (1) is designed as a metal inlay part (13) injection-molded around with the plastic of the mounting element.

7. Mounting element according to claim 1 or 6, characterized in that the cable support has a sheet-like portion (14) of said metal inlay part (13) which is arranged at that end of the cable support which is connected to the mounting element (5).

8. Mounting element according to claim 1, 6 or 7, characterized in that the screw (9) is led through the sheet-like portion (14).
